(19) United States
(12) Patent Application Publication
(10) Pub. No.: US 2015/0038218 A1
(43) Pub. Date: Feb. 5, 2015

(54) TRACKING AND RESPONDING TO WAGERING ACCOUNT ACTIVITY

(71) Applicants: Brian J. Barclay, Atlanta, GA (US); Christopher W. Blackburn, Reno, NV (US); Scott A. Massing, Lincolnwood, IL (US); John R. Werneke, Naperville, IL (US)

(72) Inventors: Brian J. Barclay, Atlanta, GA (US); Christopher W. Blackburn, Reno, NV (US); Scott A. Massing, Lincolnwood, IL (US); John R. Werneke, Naperville, IL (US)

(73) Assignee: WMS Gaming, Inc., Waukegan, IL (US)

(21) Appl. No.: 13/984,248

(22) PCT Filed: Feb. 7, 2012
(86) PCT No.: PCT/US12/24196

§ 371 Date: Jan. 22, 2014

Related U.S. Application Data
(60) Provisional application No. 61/440,639, filed on Feb. 8, 2011.

(51) Int. Cl. G07F 17/32

(52) U.S. Cl. CPC G07F 17/3288; G07F 17/3237
USPC 463/25

(57) ABSTRACT

A method includes receiving a communication regarding account activity for a player account of a wagering game player. The player account is within a group of player accounts for the wagering game player, wherein the group of player accounts includes at least one of a player account for account-based wagering at a wagering game establishment, a player account for player tracking of player activity at the wagering game establishment, and a player account for online wagering. The method includes executing a rules-based response, after receiving the communication regarding account activity. Executing the rules-based response can comprise at least one of: transmitting a player notification to the wagering game player about the account activity, to at least one of the player accounts and transmitting an account lockdown communication instructing an account server to lockdown at least one of the player accounts.

### RELATED APPLICATIONS

This application claims the priority benefit of U.S. Application Ser. No. 61/440,639 filed Feb. 8, 2011.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2012, WMS Gaming, Inc.

### FIELD

Embodiments of the inventive subject matter relate generally to wagering game systems, and more particularly to wagering game systems including tracking and messaging for wagering game account activity.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a computerized method comprises receiving a communication regarding account activity for a player account of a wagering game player, the player account within a group of player accounts for the wagering game player, wherein the group of player accounts include at least one of a player account for account-based wagering at a wagering game establishment, a player account for player tracking of player activity at the wagering game establishment, and a player account for online wagering; and executing a rules-based response, in response to receiving the communication regarding the account activity, wherein executing the rules-based response comprises at least one of, transmitting a player notification to the wagering game player about the account activity, to at least one of the player account for account-based wagering, the player account for player tracking, and the player account for online wagering; and transmitting an account lockdown communication instructing an account server hosting at least one of the player accounts to lockdown the at least one of the player accounts.

In some embodiments, the player account where the account activity occurred is different than the at least one of the player accounts to which the account lockdown communication is transmitted.

In some embodiments, the player account where the account activity occurred is different than the player account to which the player notification is transmitted.

In some embodiments, the group of player accounts comprises a player account for online non-wagering game play related to wagering game play at the wagering game establishment.

In some embodiments, the computerized method further comprises receiving a different communication regarding a player achievement by the wagering game player from the player account for player tracking of player activity at the wagering game establishment; and responsive to receiving the different communication, transmitting a notification to an operator of the wagering game establishment about the player achievement, responsive to receiving the different communication, executing a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

In some embodiments, a computerized method comprises receiving, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and transmitting, by the player account service, an account lockdown communication instructing an account server hosting a second player account within the group of player accounts to lockdown the second player account, in response to receiving the communication regarding the account activity for the first player account.

In some embodiments, the computerized method further comprises receiving, at the player account service, a different communication regarding a player achievement by the wagering game player from the player account for player tracking of player activity at the wagering game establishment; and responsive to receiving the different communication, transmitting, by the player account service, a notification over a network to an operator of the wagering game establishment about the player achievement, wherein the operator, in response to the player achievement, is to assign a player award to the player over the network to at least one of the player account for account-based wagering at the wagering game establishment, the player account for player tracking of player activity at the wagering game establishment, and the player account for online wagering.

In some embodiments, the computerized method further comprises receiving, by the player account service, a vendor message from a vendor-based server, the vendor message for transmission to a group of wagering game players, wherein the wagering game player is within the group of wagering game players; and transmitting, by the player account service, the vendor message to at least one of the player account for account-based wagering at the wagering game establishment, the player account for player tracking of player activity at the wagering game establishment, and the player account for online wagering.

In some embodiments, the computerized method further comprises receiving, at the player account service, a different communication regarding a player achievement by the wagering game player from the player account for player tracking of player activity at the wagering game establishment; responsive to receiving the different communication, transmitting, by the player account service, a notification over a network to an operator of the wagering game establishment about the player achievement; and responsive to receiving the different communication, executing, by the player account service, a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

In some embodiments, the computerized method further comprises transmitting, by the player account service, notification to a third player account to notify the wagering game player about the account activity of the first player account.

In some embodiments, an apparatus comprises a processor; a tracking module, executable on the processor, configured to receiving a communication regarding account activity for a player account of a wagering game player, the player account within a group of player accounts for the wagering game player, wherein the group of player accounts include at least one of a player account for account-based wagering at a wagering game establishment, a player account for player tracking of player activity at the wagering game establishment, and a player account for online wagering; and a messaging module, executable on the processor, configured to execute a rules-based response defined by the wagering game player, in response to receiving the communication regarding the account activity, wherein, as part of the execution of the rules-based response, the messaging module is configured to, transmit a player notification to the wagering game player about the account activity, to at least one of the player account for account-based wagering, the player account for player tracking, and the player account for online wagering; and transmit an account lockdown communication instructing an account server hosting at least one of the player accounts to lockdown the at least one of the player accounts.

In some embodiments, the player account where the account activity occurred is different than the at least one of the player accounts to which the account lockdown communication is transmitted.

In some embodiments, the player account where the account activity occurred is different than the player account to which the player notification is transmitted.

In some embodiments, the group of player accounts comprise a player account for online non-wagering game play related to wagering game play at the wagering game establishment.

In some embodiments, the tracking module is configured to receive a different communication regarding a player achievement by the wagering game player from the player account for player tracking of player activity at the wagering game establishment; wherein the messaging module is configured to transmit, responsive to receiving the different communication, a notification to an operator of the wagering game establishment about the player achievement; wherein the messaging module is configured to execute, responsive to receiving the different communication, a rules-based response defined by the operator; and wherein as part of the execution of the rules-based response, the messaging module is configured to transmit a player award to at least one of the player account for account-based wagering at the wagering game establishment, the player account for player tracking of player activity at the wagering game establishment, and the player account for online wagering.

In some embodiments, one or more machine-readable storage media includes instructions which, when executed by one or more processors, cause the one or more processors to perform operations comprises receive, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and transmit, by the player account service, an account lockdown communication instructing an account server hosting a second player account within the group of player accounts to lockdown the second player account, in response to receiving the communication regarding the account activity for the first player account.

In some embodiments, the operations comprise receiving, at the player account service, a different communication regarding a player achievement by the wagering game player from the player account for player tracking of player activity at the wagering game establishment; and responsive to receiving the different communication, transmitting, by the player account service, a notification over a network to an operator of the wagering game establishment about the player achievement, wherein the operator, in response to the player achievement, is to assign a player award to the player over the network to at least one of the player account for account-based wagering at the wagering game establishment, the player account for player tracking of player activity at the wagering game establishment, and the player account for online wagering.

In some embodiments, the operations comprise receive, by the player account service, a vendor message from a vendor-based server, the vendor message for transmission to a group of wagering game players, wherein the wagering game player is within the group of wagering game players; and transmitting, by the player account service, the vendor message to at least one of the player account for account-based wagering at the wagering game establishment, the player account for player tracking of player activity at the wagering game establishment, and the player account for online wagering.

In some embodiments, the operations comprise receiving, at the player account service, a different communication regarding a player achievement by the wagering game player from the player account for player tracking of player activity at the wagering game establishment; responsive to receipt of the different communication, transmission, by the player account service, a notification over a network to an operator of the wagering game establishment about the player achievement; and responsive to receiving the different communication, executing a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

In some embodiments, the operations comprise transmitting, by the player account service, notification to a third player account to notify the wagering game player about the account activity of the first player account.

In some embodiments, an apparatus comprises means for receiving, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and means for transmitting, by the player account service, an account lockdown communication instructing an account server hosting a second player account within the group of player accounts to lockdown the second player account, in response to receiving the communication regarding the account activity for the first player account.

In some embodiments, the apparatus further comprises means for receiving, at the player account service, a different communication regarding a player achievement by the wagering game player from the player account for player tracking of player activity at the wagering game establishment; and means for transmitting, responsive to receiving the different communication and by the player account service, a notification over a network to an operator of the wagering game establishment about the player achievement, wherein the operator, in response to the player achievement, is to assign a player award to the player over the network to at least one of the player account for account-based wagering at the wagering game establishment, the player account for player tracking of player activity at the wagering game establishment, and the player account for online wagering.

In some embodiments, the apparatus further comprises means for receiving, by the player account service, a vendor message from a vendor-based server, the vendor message for transmission to a group of wagering game players, wherein the wagering game player is within the group of wagering game players; and means for transmitting, by the player account service, the vendor message to at least one of the player account for account-based wagering at the wagering game establishment, the player account for player tracking of player activity at the wagering game establishment, and the player account for online wagering.

In some embodiments, the apparatus further comprises means for receiving, at the player account service, a different communication regarding a player achievement by the wagering game player from the player account for player tracking of player activity at the wagering game establishment; means for transmitting, responsive to receiving the different communication and by the player account service, a notification over a network to an operator of the wagering game establishment about the player achievement; and means for executing, responsive to receiving the different communication and by the player account service, a rules-based response defined by the operator, wherein means for executing the rules-based response comprises means for transmitting a player award to at least one of the player account for account-based wagering at the wagering game establishment, the player account for player tracking of player activity at the wagering game establishment, and the player account for online wagering.

In some embodiments, the apparatus further comprises means for transmitting, by the player account service, notification to a third player account to notify the wagering game player about the account activity of the first player account.

### BRIEF DESCRIPTION OF THE FIGURES

Embodiments of the invention are illustrated in the Figures of the accompanying drawings in which:

FIG. 1 depicts a wagering game system having tracking of wagering game player account activity and messaging to the player based on such account activity, according to some example embodiments.

FIG. 2 depicts a wagering game system having tracking of another type of wagering game player account activity and messaging to the player based on such account activity, according to some example embodiments.

FIG. 3 depicts a wagering game system having tracking of another type of wagering game player account activity and messaging to the player based on such account activity, according to some other example embodiments.

FIG. 4 depicts a wagering game system having tracking of another type of wagering game player account activity and messaging to the player based on such account activity, according to some other example embodiments.

FIG. 5 depicts a wagering game system having tracking of wagering game player account activity for use by a wagering game establishment operator, according to some example embodiments.

FIG. 6 depicts a wagering game system having tracking of wagering game player account activity for use by a wagering game establishment operator, according to some other example embodiments.

FIG. 7 depicts a wagering game system having tracking of wagering game player account activity for use by a vendor, according to some example embodiments.

FIG. 8 depicts a flowchart for player account protection using a player account service, according to some example embodiments.

FIG. 9 depicts a flowchart for using a player account service by an operator of a wagering game establishment, according to some example embodiments.

FIG. 10 depicts a flowchart for using a player account service by a vendor, according to some example embodiments.

FIG. 11 depicts a block diagram illustrating a wagering game machine architecture, according to some example embodiments.

FIG. 12 depicts a block diagram illustrating a wagering game network, according to some example embodiments.

FIG. 13 depicts a perspective view of a wagering game machine, according to some example embodiments.

### DESCRIPTION OF THE EMBODIMENTS

This description of the embodiments is divided into seven sections. The first section provides an introduction to some example embodiments, while the second section describes example system environments. The third section describes example operations performed by some example embodiments. The fourth section describes a wagering game machine architecture, and the fifth section describes a wagering game network. The sixth section describes an example wagering game machine and the seventh section presents some general comments.

### Introduction

This section provides an introduction to some example embodiments. Some example embodiments provide a player account service for tracking account activity of a number of different player accounts for a wagering game player in one or more wagering game environments. The account activity can occur at a number of different locations. For example, a wagering game player can login into one or more accounts at a wagering game machine at a wagering game establishment. The wagering game player can also login to an online wagering game service through any type of computer that can be coupled to a network (e.g., desktop computer, laptop computer, mobile device, etc.). The wagering game player can also login to an online account for nonwagering game activity that can be related to wagering game play at the wagering game establishments.

Also, in some example embodiments, different applications use this player account service for monitoring and messaging wagering game players at their different player accounts. For example, the player account service can be used to track and respond to suspicious account activity at the different player accounts. Suspicious account activity can include multiple logins to a same account at a same time at different locations, multiple logins to different accounts at a same time, cash-out operation from a geographical location where the wagering game player has never logged in from, etc. Some example embodiments enable the wagering game player to configure different rules for reaction to different account activity—a rules-based response. For example, in response to a player login to an online wagering account, the player can receive a text message, email, etc. For certain suspicious activity (e.g., multiple logins to a same account at a same time at different locations), the player can set a rule to lock down these player accounts, some of the player accounts, or all of the player accounts to preclude any more activity thereon.

This same player account service can also be used to track player achievements at the different player accounts and then to notify the operator of a wagering game establishment. The player account service can be used by the operator to respond to such activity. Example player activity can include different player account activity such as obtaining a certain level in a persistent state game being played at the wagering game machines at the wagering game establishment. Also, this notification to the operator may be for activity for all or just some defined groups of wagering game players. For example, this notification to the operator may be for activity of high-value players that spend above a certain monetary amount. This operator response can be a manual response by the operator and/or a rules-based response defined by the operator. For example, an operator can define a rules-based response that includes different responses based on different criteria (e.g., the type of wagering game player, the type of player achievement, the type of wagering game machine, the monetary amount spent to obtain the player achievement, etc.). To illustrate, if the player activity is to reach a certain level in a game and the player is considered a high value player, the operator response can range from a personal acknowledgement to the player, entry into a bonus round for a jackpot bonus, a monetary award, a comp award (e.g., free dinner, free room for a night at a hotel, discounted merchandise, etc.).

This same player account service can also be used to enable vendor messaging to one or more player accounts. Such vendor messaging can include advertising, discounted or free products or services, etc. Some example embodiments enable vendors or other third parties to have access to the multiple player accounts of the wagering game players under the control of the player account service. The wagering game establishment can charge these vendors and third parties for such access. In some example embodiments, the wagering game establishment can auction such access to certain groups of wagering game players (based on age, gender, monies spent, etc.) to a number of different vendors. Also, vendors having access can change based on the month, the day of the week, time of day, etc. For example, vendor A has access from 12 a.m. to 12 p.m., and vendor B has access from 12 p.m. to 12 a.m. Also, the wagering game player can configure their player accounts not to receive the vendor messaging. For example, the wagering game player can configure their player accounts such that none, one, some or all of their player accounts receive the vendor messaging. In some example embodiments, such vendor messaging can be an opt-in option on the player accounts. Accordingly, the default option is that the wagering game player will not receive the vendor messaging on any of their player accounts.

This same player account service can be used for other types of player account notifications. For example, the player account service can be used to notify a wagering game player regarding status of their win-while-your-away gaming or notification of friends in a social network regarding their wagering game play (e.g., notification at the player account when a friend logs into one of their accounts, notification at the player account when a friend wins, etc.).

### System Environments

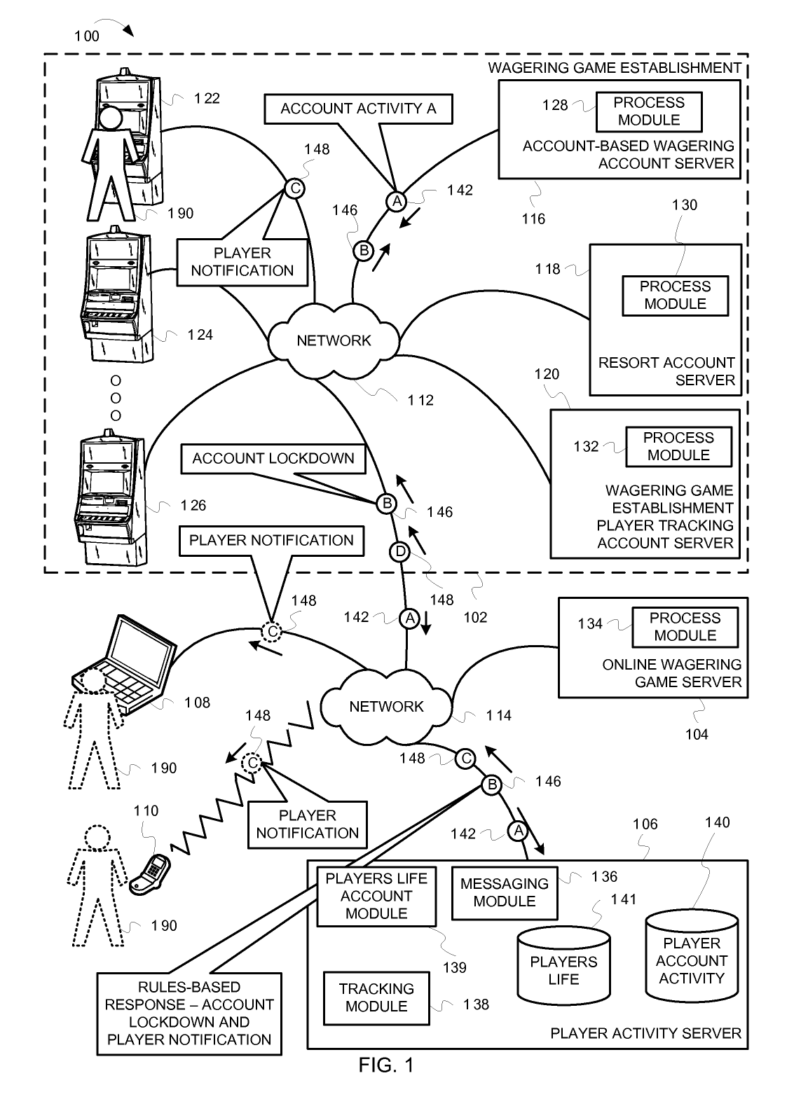

This section describes various system environments of some example embodiments. This section includes various configurations for tracking and responding to wagering game account activity. The systems described herein include a player activity server that provides a player account service for tracking and monitoring of player account activity. The player account service can be for multiple wagering game-related accounts (e.g., account-based wagering account for a wagering game establishment, player tracking account for a wagering game establishment, player account for online wagering account, a player's life account for tracking player activity, etc.). The player account service can also provide messaging to the player regarding certain player account activity (e.g., suspicious account activity), messaging to an operator of the wagering game establishment (e.g., player activity for defined group of players for rewarding the player), messaging related to targeted advertising of a defined group of players (e.g., high value players), etc. Accordingly, a same player account server provides different types of tracking and different types of messaging in a wagering game environment. The section will discuss FIGS. 1-7 and is separated into three subsections. While separately described across different figures, these different operations can be incorporated into a same system. For example, the player account protection operations can be combined with the use by the operator of the wagering game establishment and with use by vendors. Also, while the player account service is described as being within a player activity server, in some other example embodiments, the player account service can be in other servers, can be partitioned across multiple services, can be at least partially within one or more wagering game machines, etc.

The first subsection will discuss FIGS. 1-4, which describes tracking of player account activity across multiple wagering game accounts. Also, in response to such activity, there are different types of rules-based responses that are dependent on the type of account, the activity, the location, etc. For example, the responses can include player notification (e.g., email, text message, telephone call, etc.), lock down of one or more of the player accounts, notification of other persons (e.g., defined friends), etc.

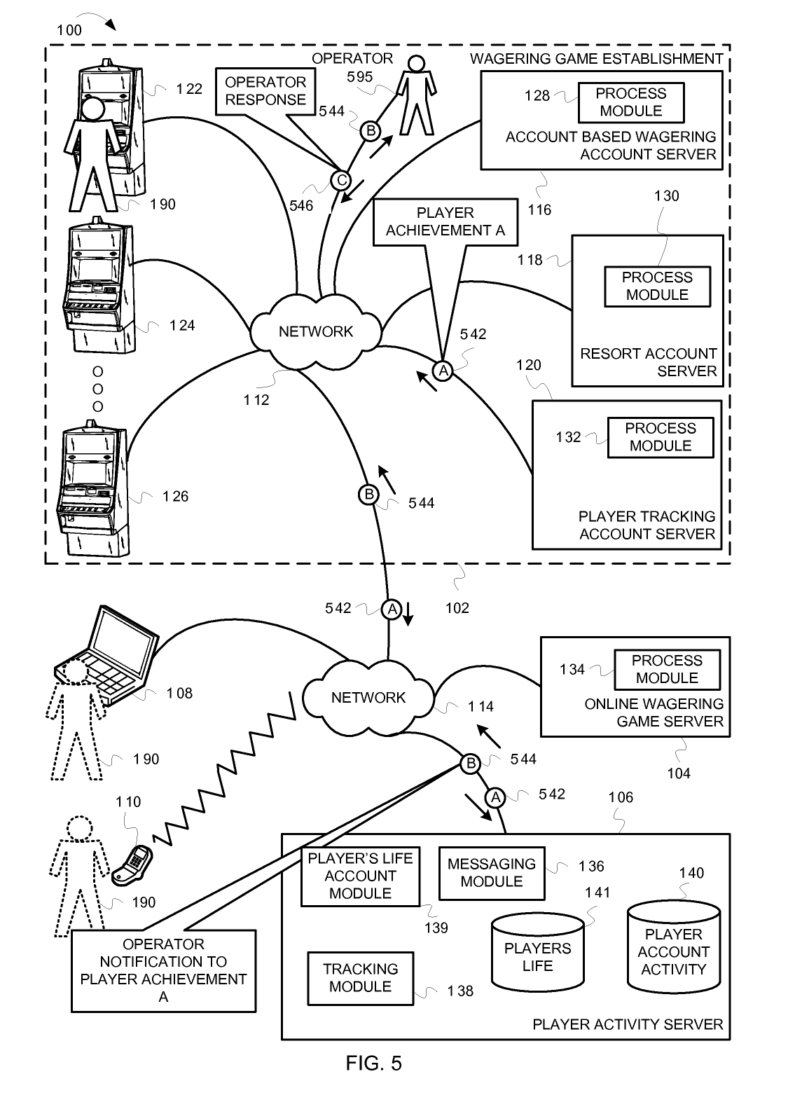

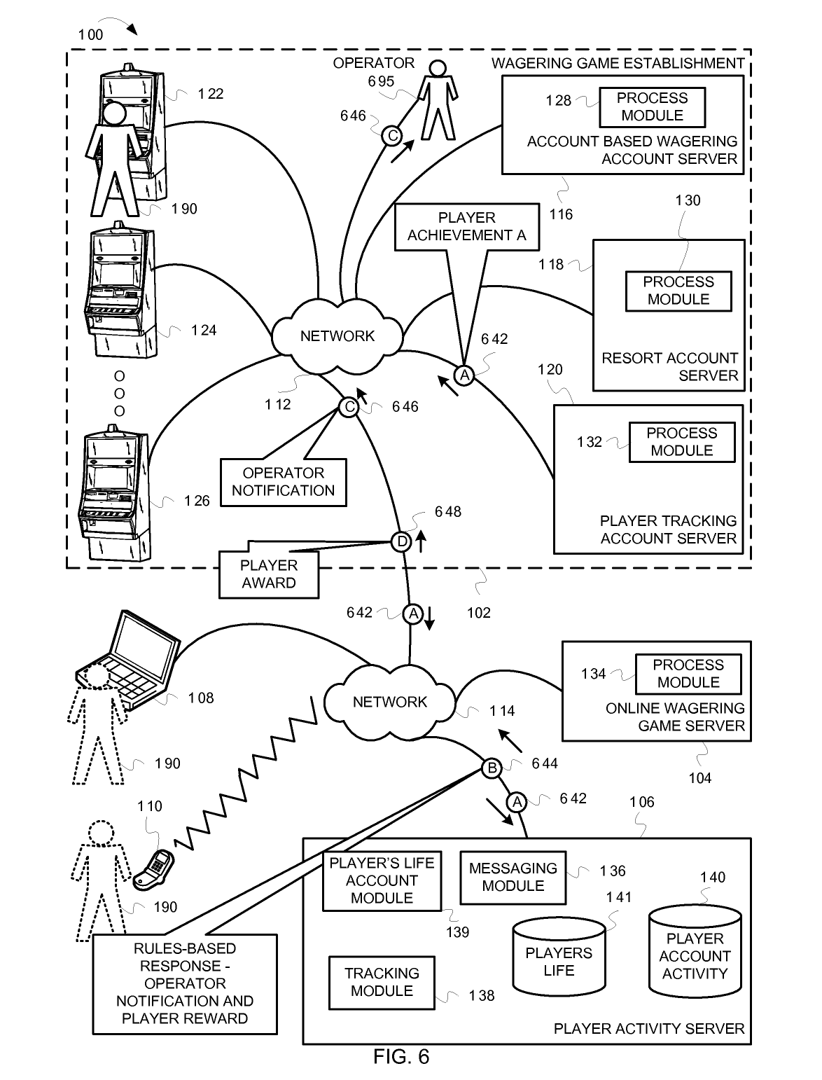

The second subsection will discuss FIGS. 5-6, which also describes tracking of player account activity across multiple wagering game accounts. In response to such activity, the operator is notified of such activity and/or there are different types of operator-defined responses that that are dependent on the type of account, the activity, the location, etc. For example, if the player activity is to reach a certain level in a game and the player is considered a high value player, the operator response can range from a personal acknowledgement to the player, entry into a bonus round for a jackpot bonus, a monetary award, a comp award (e.g., free dinner, free room for a night at a hotel, discounted merchandise, etc.).

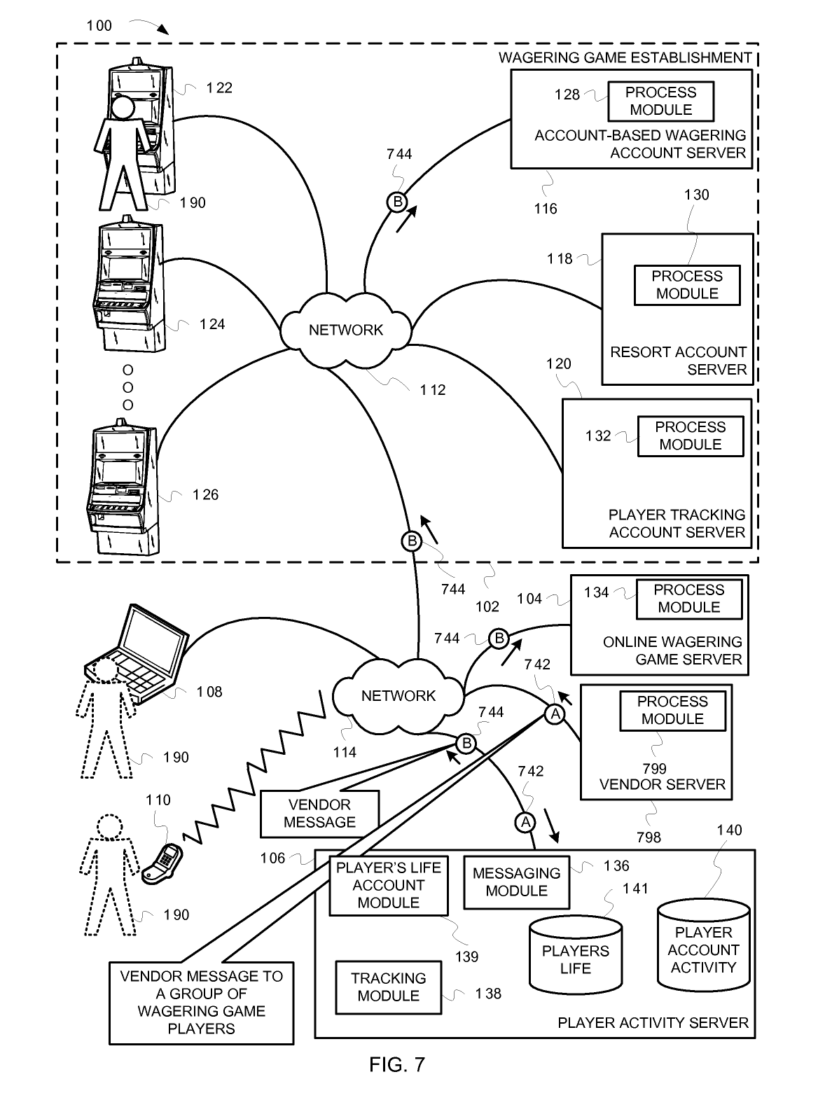

The third subsection will discuss FIG. 7, which describes messaging to a defined group of players for marketing, advertising, etc. Such messaging can provide complimentary or discounted products (e.g., free beverage, discounted concert tickets, etc.). The messaging can be to different player accounts and can be filtered relative to player preferences (as further described below).

### Player Account Protection

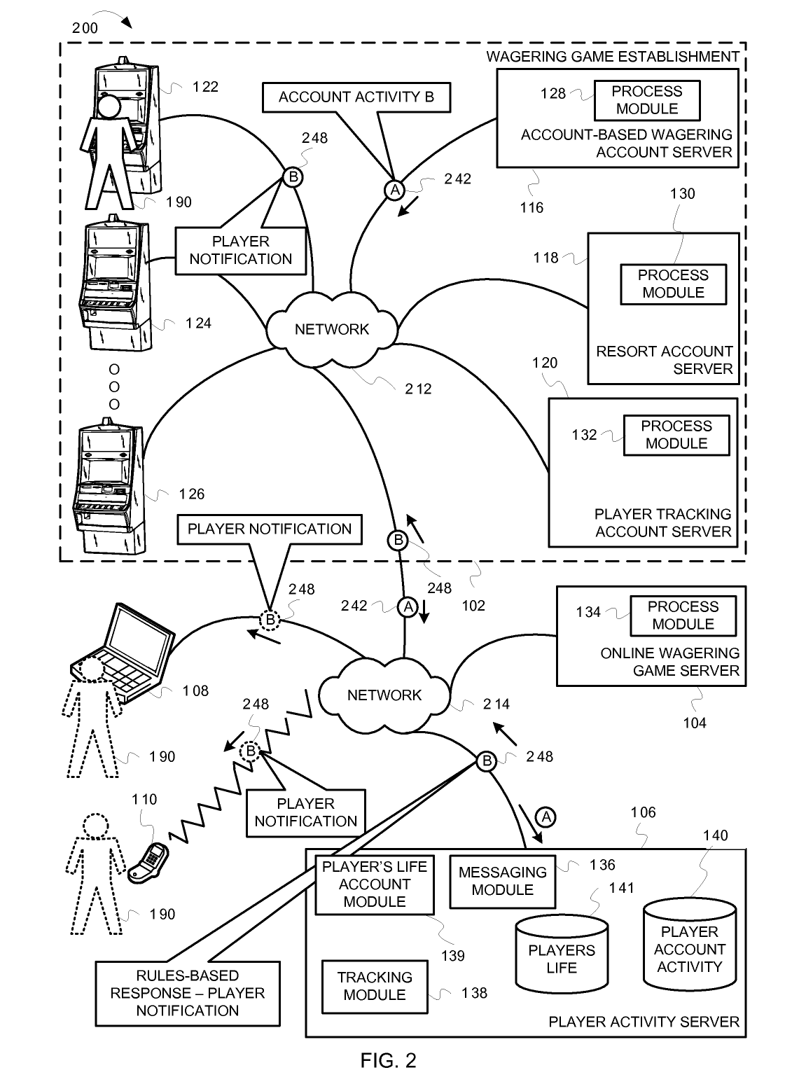

FIG. 1 depicts a wagering game system having tracking of wagering game player account activity and messaging to the player based on such account activity, according to some example embodiments. In particular, FIG. 1 depicts a wagering game system in response to a first player account activity (“account activity A”). As further described below, FIGS. 2-4 depict the wagering game system in response to other player account activity. For the same components, FIGS. 1-4 are using a same reference number (e.g., wagering game machine 122).

FIG. 1 depicts a wagering game system 100 that includes a wagering game establishment 102. In the wagering game system 100, a wagering game player can have a number of different player accounts related to wagering game activity. In this example, a wagering game player 190 has five different player accounts. A first player account is an account-based wagering account provided by an account-based wagering account server 116. A second player account is a resort account provided by a resort account server 118. A third player account is a player tracking account for the wagering game establishment 102 provided by the wagering game establishment player tracking server 120. A fourth player account is an online wagering game account provided by an online wagering game server 104. A fifth player account is a player's life account provided by a player activity server 106. A more detailed description of these different player accounts is set forth below. Also as further described below, the player activity server 106 provides operations for tracking account activity across these different player accounts and providing player defined responses to such activity (depending on the type of account, the type of activity, etc.).

The wagering game system 100 also includes a computer (e.g., laptop computer) 108 and a mobile device 110. The wagering game establishment 102 includes a number of wagering game machines (shown as a wagering game machine 122, a wagering game machine 124, and a wagering game machine 126). In this embodiment, under the control of the wagering game establishment 102, the wagering game establishment 102 includes the account-based wagering account server 116, the resort account server 118, and the player tracking account server 120.

The account-based wagering account server 116 includes a process module 128. The resort account server 118 includes a process module 130. The player tracking account server 120 includes a process module 132. The process module 128, the process module 130, and the process module 132 can be software, firmware, hardware or a combination thereof. Although not shown, the account-based wagering account server 116, the resort account server 118, and the player tracking account server 120 can include nonvolatile machine-readable media for storage of data related to different wagering game players' accounts at the wagering game establishment 102. The process module 128, the process module 130, and the process module 132 can receive, transmit, and process data related to the different wagering game players' accounts at the wagering game establishment 102.

Within the wagering game establishment 102, there is a network 112. The wagering game machine 122, the wagering game machine 124, the wagering game machine 126, the account-based wagering account server 116, the resort account server 118, and the player tracking account server 120 are communicatively coupled together through the network 112. External to the wagering game establishment 102, there is another network—a network 114. The network 112 and the network 114 are communicatively coupled together.

The online wagering game server 104 includes a process module 134. The process module 134 can be software, firmware, hardware or a combination thereof. Although not shown, the online wagering game server 104 can also include nonvolatile machine-readable media for storage of data related to wagering game players' online wagering accounts.

In this embodiment, the player activity server 106 is configured to provide multiple operations related to wagering game activity. The player activity server 106 includes a messaging module 136, a tracking module 138, a player's life account module 139, a player account activity database 140, and a player's life database 141. The combination of the tracking module 138, the messaging module 136, and the player account activity database 140 provides a player account service for tracking and messaging of activities occurring at player accounts of wagering game players.

Although not shown, the messaging module 136, the tracking module 138, the player's life account module 139, the player account activity database 140, and the player's life database 141 are communicatively coupled together. The messaging module 136, the tracking module 138, and the player's life account module 139 can be software, firmware, hardware, or a combination thereof. The player account activity database 140 and the player's life database 141 can be stored in nonvolatile machine-readable media. In some example embodiments, the different functionality provided by the player activity server 106 can be separated into separate servers or devices that are coupled to the network 114. For example, the player's life account module 139, the messaging module 136, and the tracking module 138 can each be in different servers.

In this embodiment, the wagering game player 190 is shown as playing a wagering game at the wagering game machine 122 in the wagering game establishment 102. Also shown, at other times, the wagering game player 190 can be accessing one or more accounts or be accessible for receiving messaging through the computer 108 or the mobile device 110. For example, the wagering game player 190 can use the computer 108 to access the online wagering game server 104 for playing wagering games. The wagering game player 190 can receive messages a number of different ways. For example, the wagering game player 190 can receive messages while playing wagering games at the wagering game machine 102 (e.g., pop-up window), while being online on one of their player accounts (e.g., online wagering game account, player's life account, etc.), emails or text messages through the computer 108 and/or the mobile device 110. The wagering game player 190 can also receive messages through a telephone call (e.g., through the mobile device 110).

For the account-based wagering account server 116, the process module 128 executing therein provides access to player accounts for account-based wagering. In particular, a wagering game player can have a player account for account-based wagering, wherein the wagering game player can play wagering games at the different wagering game machines at the wagering game establishment 102 based on monies electronically stored in this player account. For example, after a player login at the wagering game machine, the player can authorize a given dollar amount to be wagered using the player's account. The wagering game machine can then enable wagering game play based on a player's account managed by the account-based wagering account server 116. After a game play, the wagering game machine can transmit a communication back to the account-based wagering account server 116 to report wins and losses. The process module 128 can then update the player's account based on this communication.

For the resort account server 118, the process module 130 executing therein provides access to player accounts for various resort amenities. For example, the wagering game player can charge their hotel room, hotel services, meals, various merchandise (e.g., clothing), etc. to this player account. This player account can be accessed at different locations in the wagering game establishment 102 using a card with a magnetic strip, username and password authentication, etc.

For the player tracking account server 120, the process module 132 executing therein provides access to a different player account for tracking player activity at the different wagering game machines. For example, the wagering game player can login to this player account to obtain comps based on wagering game play, to track progress in a persistent-state game being played at the wagering game machine, etc.

For the online wagering game server 104, the process module 134 executing therein provides access to another player account that enables a wagering game player to play wagering games online and outside a brick-and-mortar wagering game establishment. The wagering games can include poker, blackjack, slot machines, etc. In this embodiment, the wagering game player 190 is accessing this player account using the computer 108 and/or the mobile device 110.

For the player activity server 106, the player's life account module 139 provides access to player's life accounts for wagering game players on a website that is external to the wagering game establishment 102. The data for the different player accounts can be stored in the player's life database 141. A player's life account enables wagering game players to stay connected to wagering gaming even though the wagering game players are not present at the wagering game establishment 102. A player's life account provides access to online content that incentivizes or drives the wagering game player to return to the wagering game establishment 102. An example of the online content includes non-wagering game content or games. Generally, the purpose of the non-wagering game content is to remind or incentivize the player to return to the wagering game establishment. For example, the non-wagering games have a relationship to, or commonality with, the wagering game experiences at the wagering game establishment 102 (e.g., non-wagering games may have the same theme, characters, etc. as the player's favorite wagering games). The player's life account can also include social networking aspects where a player can communicate with social contacts that are also involved in wagering games (e.g., other gamers that have registered with the player's life website, that also have wagering game accounts, etc.), participate in forums, preview of new wagering games, etc.

In some example embodiments, the player's life online content may cooperate or integrate with games at the wagering game machines at the wagering game establishment 102 in some way that incentivizes interaction between online activity and activity at the wagering game establishment 102. For example, the player's life non-wagering games may integrate with a persistent state game that can progress by back and forth interactivity through the wagering game establishment 102 and the website for accessing the online content. In other words, a player advances to a certain point in the persistent-state game via wagering play at the wagering game establishment 102, which unlocks the online content (e.g., non-wagering games, episodic content via the website, new features of the website, etc.) which is only accessible via the player's life account at the website. Then, the persistent-state game is limited in progress until the player visits the website, accesses the unlocked online content, and performs some activity with the online content (e.g., completes a game level for a non-wagering game), which then unlocks wagering-game content (e.g., a new wagering-game bonus or feature) that is only accessible via access from a wagering game machine at the wagering game establishment 102. In addition to unlocking the wagering-game content, the activity that the player performs with the online content can cause additional progress in the persistent-state game. The activity from the player via the player's life account attempts to incentivize the player to return to the wagering game establishment, and vice versa.

Also, in some example embodiments, the persistent-state game is configured to react to both the player's life account and the account at the wagering game establishment 102. In some example embodiments, both accounts can write to the same database entries, for example, that relate to progress indicators for the persistent-state game. For example, the persistent-state game acts like a storage means (e.g., like a game board that tracks progress) that can be used for wagering game establishment activity and for online activity. In other words, the persistent-state game is a means of tracking and storing progress for the persistent-state game while the player is logged in to their player account at the wagering game establishment 102 and while the player is logged on to their player's life account.

The player activity server 106 also includes the tracking module 138. In some example embodiments, the tracking module 138 receives communication about some or all activity involving the different player accounts. For example, the tracking module 138 can receive communication regarding activity related to the players account for account-based wagering from the process module 128 of the account-based wagering account server; communication regarding activity related to the players account for the resort from the process module 130 of the resort server 118; communication regarding activity related to the players tracking account for player tracking at the wagering game establishment 102 from the process module 132 of the player tracking account server 120; communication regarding the players account related to online wagering from the process module 134 of the online wagering game server 104; and communication regarding players account related to player's life activity from the player's life account module 139 of the player activity server 106. In addition to the type of activity, the tracking module 138 can also receive a network address, network zone, date and time, identification of wagering game establishment (if applicable), browser type (if applicable), the previous wagering game establishments where access occurred, length of time on the account, money spent, etc. related to the activity. In some example embodiments, a plug-in application can be required to be installed onto the device that is attempting to access a player account prior to account access. The plug-in application can provide additional data about the device that is being used to access the player account (e.g., Media Access Control (MAC) address, device name, token code that is unique to the device, etc. This additional data can also be provided to the tracking module 138 for tracking the activity.

In some example embodiments, the tracking module 138 can receive communications regarding only selected activities. For example, any activities related to player login, money transfers, etc. are communicated to the tracking module 138. Also, any activities related to suspicious account activities are communicated to the tracking module 138. For example, if a player is logged into one or more player accounts at two different geographic locations at a same time, the activity is communicated to the tracking module 138. This central tracking across multiple player accounts enables better tracking of such suspicious activity. This central tracking allows cross-referencing across multiple player accounts for a same player. In particular, in a conventional configuration and in contrast to some example embodiments, player account A is generally not aware of the activity of player account B. For example, the tracking module 138 can be aware when a wagering game player is logged into their player account for account-based wagering at the wagering game machine 122 at the wagering game establishment 102 and when, at the same time, the same wagering game player is logged into their player account for online wagering from a computer that is off-site from the wagering game establishment 102. Being logged into two different accounts at a same time at two different machines in two different geographic locations can be considered suspicious activity. In some example embodiments, being logged into a same account at a same time can also be considered suspicious activity. Accordingly, the tracking module 138 can track all player account logins across the different player accounts. As described below, a player can define different rules-based responses to different activities (including such various suspicious activities).

The tracking module 138 can store these different communications related to the player account activities from the different player accounts in the player account activity 140. The tracking module 138 can track and store such activities for any number of wagering game players across any number of wagering game establishments for any number of wagering game accounts.

The messaging module 136 can process these different communications related to the player account activities and perform one or more operations in response to such activities based on rules-based responses. In some example embodiments, the rules-based responses are defined by the wagering game player. The rules-based responses can define how to respond based on the type of account activity, the type of account, the location of the activity, the time and date of the activity, etc. For example, if a same wagering game player is logged into two different accounts or a same account at a same time, the rules-based response can include instructions to lock down one, some or all of the player accounts, notify the wagering game player through one or more means (e.g., email, text, telephone call, pop-window on an account at a machine the player is current using, etc.).

In FIG. 1, the process module 128 of the account-based wagering game account server 116 transmits a communication 142 regarding account activity A (see point A). The communication 142 is transmitted over the network 112 and the network 114 to the tracking module 138 of the player activity server 106. The tracking module 138 can store the communication 142 in the player account activity database 140. Also, the messaging module 136 can process the communication 142 to determine if a rules-based response is executed. For example, assume that the account activity A includes a login to the player account for account-based wagering for the wagering game player 190 at the wagering game machine 122. Also, assume that the wagering game player 190 is currently logged in to their player account for online wagering using the computer 108.

In this example, the rules-based response is an account lockdown of the player account for the account-based wagering and player notification—shown as two different communications (a communication 146 at point B and a communication 148 at point C). The communication 146 (shown at point C) is for account lockdown and is transmitted to the account-based wagering account server 116. In response, the process module 128 locks down player account for account-based wagering such that no further activity can occur in the player account (e.g., logins, cash out, etc.).

The communication 148 (shown at point C) is for player notification and is transmitted to multiple locations. In this example, the communication 148 is transmitted to the wagering game machine 122, where the wagering game player 190 is playing. In response to receipt of the communication, the wagering game machine 122 can display a message on one of its displays. Also in this example, the communication 148 is being transmitted to the mobile device 110 of the wagering game player 190. For example, the communication 148 can be in the form of an email, a text message, a telephone call, etc. Also in this example, the communication 148 is being transmitted to the computer 108. For example, the communication 148 can be transmitted to one or more of the player accounts (e.g., the online wagering game account, the player's life account, etc.), be transmitted as an email, instant message, etc. In some example embodiments, as part of the rules-based response, the wagering game player can customize various parts of the response (e.g., player notification). For example, for account activities external to the wagering game establishment (e.g., the online wagering game account or the player's life account), the wagering game player can configure the response not to receive the player notification at a wagering game machine in the wagering game establishment 102. In another example, the wagering game player can elect to perform an account lockdown of all the player accounts if there is a suspicious cash out operation (e.g., cash out at a geographic location that the wagering game player has never previously logged in from).

In some example embodiments, if the activity is from a network address or a browser type that was previously not used to access the account, the player can cause the account to be locked down. For example, assume that a wagering game machine has a network address wherein account-based wagering can occur. If the account is accessed from some wagering game establishment that a player has never previously accessed from their online account, the player can configure their account to lock down.

In some example embodiments, multi-factor authentication can be used for certain account activity. For example, certain activities on player accounts can require a password and biometric data (e.g., fingerprint, face recognition, etc.), one-time passwords, etc. In some example embodiments, this multi-factor authentication can be required after a suspicious activity. For example, if a suspicious activity occurs at one player account, a rules-based response can require multi-factor authentication for the other player accounts for the wagering game player. Alternatively or in addition, the multi-factor authentication can be required for certain activities (e.g., cash-out operations).

In some example embodiments, additional player confirmation can be required for certain account activity. For example, certain activities on player accounts can require player confirmation via email, telephone call, etc. In particular, the player receives an email or telephone call and must respond a certain way prior to allowing the account activity. In some example embodiments, this player confirmation can be required after a suspicious activity. For example, if a suspicious activity occurs at one player account, a rules-based response can require player confirmation for the other player accounts for the wagering game player. Alternatively or in addition, the player confirmation can be required for certain activities (e.g., cash-out operations).

FIG. 2 depicts a wagering game system having tracking of another type of wagering game player account activity and messaging to the player based on such account activity, according to some example embodiments. In particular, FIG. 2 depicts the wagering game system 100 of FIG. 1, in response to a second player account activity (“account activity B”). As noted above, FIG. 2 uses the same reference numbers for the components that are the same as those in FIG. 1. In this example, the components that are different from those in FIG. 1 include the communications regarding the player account activity and the rules-based response.

Similar to FIG. 1, the account activity in FIG. 2 (account activity B) is also from a player account for account-based wagering. In particular, the process module 128 of the account-based wagering game account server 116 transmits a communication 242 regarding account activity B (see point A). The communication 242 is transmitted over the network 112 and the network 114 to the tracking module 138 of the player activity server 106. The tracking module 138 can store the communication 242 in the player account activity database 140. Also, the messaging module 136 can process the communication 242 to determine if a rules-based response is executed. For example, assume that the account activity B includes a login to the player account for account-based wagering for the wagering game player 190 at the wagering game machine 122. Also, assume that the wagering game player 190 is not currently logged in to any other player accounts.

In this example, the rules-based response is player notification—shown as a communication 248 at point B. In this example, the player notification is also being transmitted to multiple locations. The communication 248 is transmitted to the wagering game machine 122, where the wagering game player 190 is playing. In response to receipt of the communication, the wagering game machine 122 can display a message on one of its displays. Also in this example, the communication 248 is being transmitted to the mobile device 110 of the wagering game player 190. For example, the communication 248 can be in the form of an email, a text message, a telephone call, etc. Also in this example, the communication 248 is being transmitted to the computer 108. For example, the communication 248 can be transmitted to one or more of the player accounts (e.g., the online wagering game account, the player's life account, etc.), be transmitted as an email, instant message, etc. As shown by the wagering game system 100 across FIGS. 1-2, two different account activities from a same player account can result in two different responses.

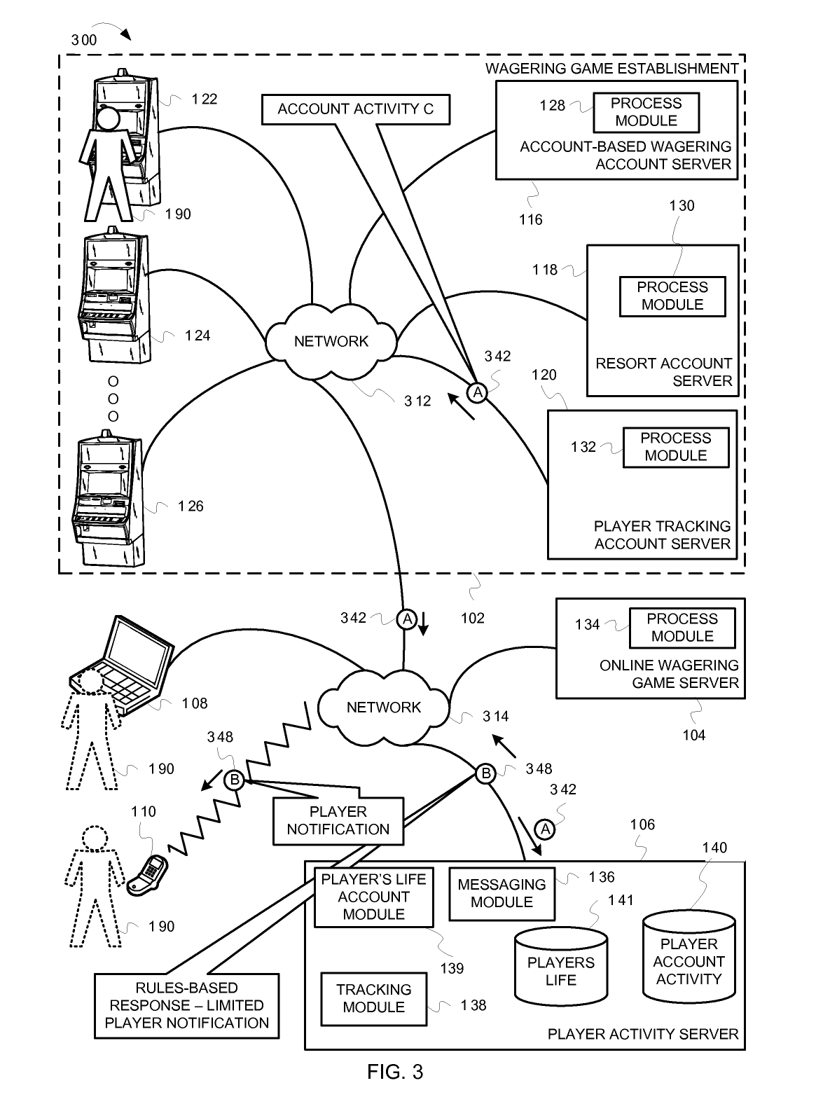

FIG. 3 depicts a wagering game system having tracking of another type of wagering game player account activity and messaging to the player based on such account activity, according to some other example embodiments. In particular, FIG. 3 depicts the wagering game system 100 of FIG. 1, in response to a third player account activity (“account activity C”). As noted above, FIG. 3 uses the same reference numbers for the components that are the same as those in FIG. 1. In this example, the components that are different from those in FIG. 1 include the communications regarding the player account activity and the rules-based response.

The account activity in FIG. 3 (account activity C) is also from a player account for player tracking at the wagering game establishment 102. In particular, the process module 132 of the player tracking account server 120 transmits a communication 342 regarding account activity C (see point A). The communication 342 is transmitted over the network 112 and the network 114 to the tracking module 138 of the player activity server 106. The tracking module 138 can store the communication 342 in the player account activity database 140. Also, the messaging module 136 can process the communication 342 to determine if a rules-based response is executed. For example, assume that the account activity C includes a change of the password for this player account for player tracking.

In this example, the rules-based response is limited player notification—shown as a communication 348 at point B. In this example, the player notification is only transmitted to the mobile device 110 of the wagering game player. For example, the communication 348 can be in the form of an email, a text message, a telephone call, etc. As shown by the wagering game system 100 across FIGS. 1-3, a different account activity (considered of lesser importance) from a different player account results in a limited response in FIG. 3, relative to the operations in FIGS. 1-2.

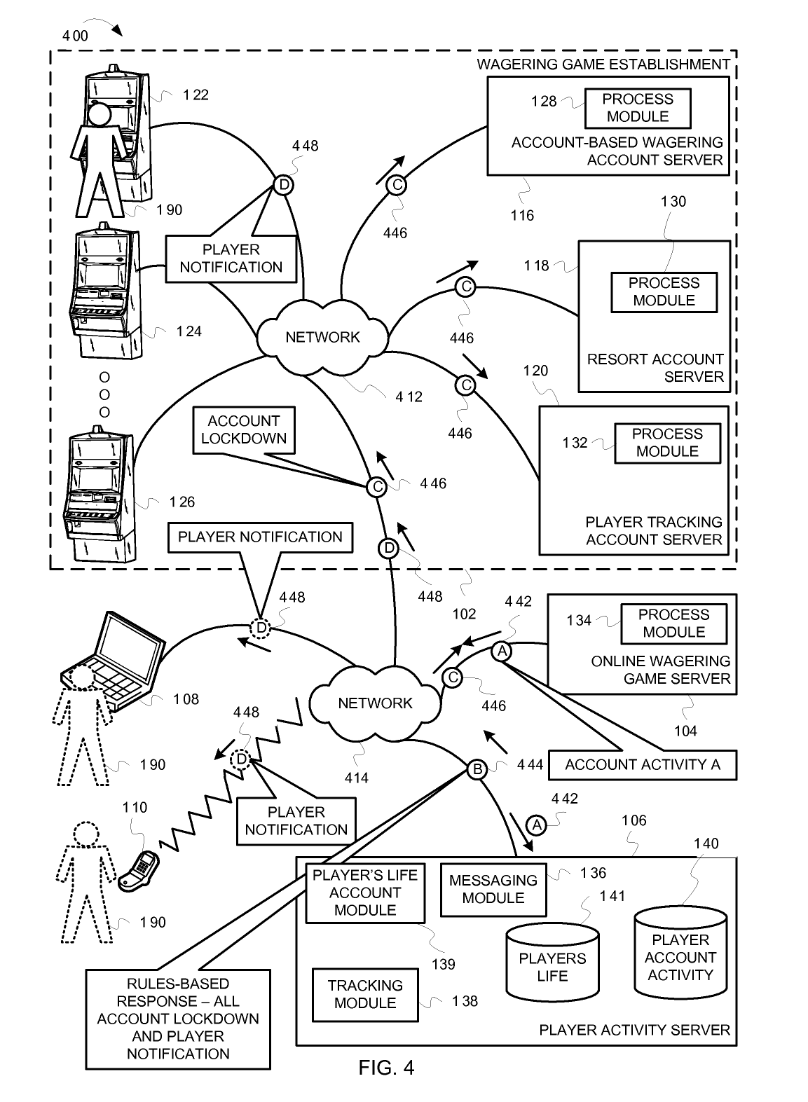

FIG. 4 depicts a wagering game system having tracking of another type of wagering game player account activity and messaging to the player based on such account activity, according to some other example embodiments. In particular, FIG. 4 depicts the wagering game system 100 of FIG. 1, in response to the same player account activity that occurred in FIG. 1 (“account activity A”), but from a different player account. As noted above, FIG. 4 uses the same reference numbers for the components that are the same as those in FIG. 1. In this example, the components that are different from those in FIG. 1 include the communications regarding the player account activity and the rules-based response.

In FIG. 4, the account activity (account activity A) is from a player account for online wagering. In particular, the process module 134 of the online wagering game server 104 transmits a communication 442 regarding account activity A (see point A). The communication 442 is transmitted over the network 114 to the tracking module 138 of the player activity server 106. The tracking module 138 can store the communication 442 in the player account activity database 140. Also, the messaging module 136 can process the communication 442 to determine if a rules-based response is executed. As described above, the account activity A includes a login to the player account for online wagering for the wagering game player 190 using the computer 108. Also, assume that the wagering game player 190 is currently logged in to their player account for account-based wagering using the wagering game machine 122.

In this example, the rules-based response is an account lockdown of all of the player accounts and player notification—shown as a communication 444 at point B. The communication 444 comprises two different communications. The first communication is a communication 446 (shown at point C) for account lockdown for all player accounts and being transmitted to all of the different servers maintaining the different player accounts. In particular, the communication 446 is transmitted to the account-based wagering account server 116, the resort account server 118, the player tracking account server 120, the online wagering game server 104, and the player's life account module 139. In response, the process modules 128-134 and the player's life account module 139 locks down their associated players account such that no further activity can occur in the player account (e.g., logins, cash out, etc.).

The second communication is a communication 448 (shown at point D) for player notification and being transmitted to multiple locations. In this example, the communication 448 is transmitted to the wagering game machine 122, where the wagering game player 190 is playing. In response to receipt of the communication, the wagering game machine 122 can display a message on one of its displays. Also in this example, the communication 448 is being transmitted to the mobile device 110 of the wagering game player 190. For example, the communication 448 can be in the form of an email, a text message, a telephone call, etc. Also in this example, the communication 448 is being transmitted to the computer 108. For example, the communication 448 can be transmitted to one or more of the player accounts (e.g., the online wagering game account, the player's life account, etc.), be transmitted as an email, instant message, etc. As shown by the wagering game system 100 across FIGS. 1 and 4, two different account activities from a same player account from two different player accounts can result in two different responses.

### Use by a Wagering Game Establishment Operator

This subsection includes the description of FIGS. 5-6 and relates to wagering game systems that track wagering game player account activity for use by a wagering game establishment operator. In contrast to FIGS. 1-4, FIGS. 5-6 depicts operations for notifying an operator at the wagering game establishment of certain player activity and enabling the operator to respond to such activity. Example player activity can include different player account activity such as obtaining a certain level in a persistent state game being played at the wagering game machines at the wagering game establishment. Also, this notification to the operator may be for activity of all or just some defined groups of wagering game players. For example, this notification to the operator may be for activity of high-value players that spend above a certain monetary amount. As described below, this same tracking module and messaging module used relative to certain suspicious account activity as described in FIGS. 1-4 can also be used for operator notification and response to player achievements relative to player accounts at the wagering game machines.

FIG. 5 depicts a wagering game system having tracking of wagering game player account activity for use by a wagering game establishment operator, according to some example embodiments. FIG. 5 uses the same reference numbers for the components that are the same as those in FIGS. 1-4.

In operation, the process module 132 of the player tracking account server 120 transmits a communication 542 regarding a player achievement A (see point A). The communication 542 is transmitted over the network 112 and the network 114 to the tracking module 138 of the player activity server 106. The tracking module 138 can store the communication 542 in the player account activity database 140. Also, the messaging module 136 can process the communication 542 to determine if whether the operator is notified. For example, the operator can be notified only if the wagering game player is within a certain category of players (e.g., high-value players) and if a certain achievement is obtained. In another example, the operator can be notified for any player that achieves a certain type of achievement. In this embodiment, the messaging module 136 transmits a communication 544 to notify an operator 595 of the wagering game establishment 102 about the player achievement A (see point B). The communication 544 can be provided to the operator through a number of means (e.g., email, text message or telephone call to their mobile device, email or text message to an account that the operator 595 can access, etc.).

In this embodiment, the operator 595 transmits a communication 546 as an operator response to the player achievement A (see point C). The communication 546 can be a personal message to the player to one or more of their player accounts (e.g., congratulations message, notification of player entry into a special bonus round at one of the wagering game machines, notification of free credits for wagering game play added to one or more of their accounts, free comps, etc.). Alternatively or in addition, the communication 546 can also be a communication to the wagering game machine where the wagering game player 190 is current logged in and/or the process module 132 in the player tracking server 120. Such a communication can authorize entry of the wagering game player 190 into a bonus round of the wagering game machine where the player is logged in. Alternatively or in addition, the communication 546 can be a communication to the process module 128 of the account based wagering account server 116 to credit the player account with a number of free credits. Alternatively or in addition, the communication 546 can be a communication to the process module 130 of the resort account server 118 to credit the player account for the resort with some type of comp (e.g., free or discounted dinner or merchandise, free or discounted resort hotel room or suite, free or discounted event tickets, etc.). Alternatively or in addition, the communication 546 can be a communication to the process module 134 of the online wagering game server 104 to credit the player account with a number of free credits.

FIG. 6 depicts a wagering game system having tracking of wagering game player account activity for use by a wagering game establishment operator, according to some other example embodiments. In contrast to FIG. 5 where the operator is notified, FIG. 6 includes operations wherein the operator at the wagering game establishment 102 can define rules-based responses to player achievements (similar to the rules-based responses in FIGS. 1-4). FIG. 6 uses the same reference numbers for the components that are the same as those in FIGS. 1-5.

In operation, the process module 132 of the player tracking account server 120 transmits a communication 642 regarding a player achievement A (see point A). The communication 642 is transmitted over the network 112 and the network 114 to the tracking module 138 of the player activity server 106. The tracking module 138 can store the communication 642 in the player account activity database 140.

Also, the messaging module 136 can process the communication 542 to determine if a rules-based response is executed. There can be a number of different responses that vary based on their different rules. For example, a first rules-based response can require that a response is to occur only if the wagering game player is within a certain category of players (e.g., high-value players) and if a certain achievement is obtained. A second rules-based response may not be limited to a certain category of players but can require that a response is to occur only if a certain type of achievement obtained. Also, the rules-based response can define the specific response if the achievement qualifies for a response.

In this example, the rules-based response is operator notification and a player award—shown as a communication 644 at point B. The communication 644 comprises two different communications. The first communication is a communication 646 (shown at point C) for notifying the operator of the achievement and the player being providing award (similar to the communication 544 of FIG. 5). The communication 644 can be provided to an operator 695 through a number of means (e.g., email, text message or telephone call to their mobile device, email or text message to an account that the operator 595 can access, etc.).

The second communication is a communication 648 (shown at point D) for a player reward that can be transmitted to one or more locations. The communication 648 can be a personal message to the player to one or more of their player accounts (e.g., congratulations message, notification of player entry into a special bonus round at one of the wagering game machines, notification of free credits for wagering game play added to one or more of their accounts, free comps, etc.). Alternatively or in addition, the communication 648 can also be a communication to the wagering game machine where the wagering game player 190 is current logged in and/or the process module 132 in the player tracking server 120. Such a communication can authorize entry of the wagering game player 190 into a bonus round of the wagering game machine where the player is logged in. Alternatively or in addition, the communication 648 can be a communication to the process module 128 of the account based wagering account server 116 to credit the player account with a number of free credits. Alternatively or in addition, the communication 648 can be a communication to the process module 130 of the resort account server 118 to credit the player account for the resort with some type of comp (e.g., free or discounted dinner or merchandise, free or discounted resort hotel room or suite, free or discounted event tickets, etc.). Alternatively or in addition, the communication 648 can be a communication to the process module 134 of the online wagering game server 104 to credit the player account with a number of free credits. As shown by the wagering game system 100 across FIGS. 1-6, a same tracking module and messaging module can perform different operations related to player account activity.

### Use by a Vendor

This subsection includes the description of FIG. 7 and relates to wagering game systems that track wagering game player account activity for use by a vendor. In particular and in contrast to FIGS. 1-4, FIG. 7 depicts operations for enabling a vendor to communicate with the player through their multiple player accounts. Such communication can include advertising, discounted or free products or services, etc. As described below, this same tracking module and messaging module used relative to certain suspicious account activity as described in FIGS. 1-4 can also be used for vendor communications with players through their multiple player accounts. The example embodiments described in this subsection enables vendors or other third parties to have access to the multiple player accounts of the wagering game players under the control of the player account server 106. The wagering game establishment can charge these vendors and third parties for such access. In some example embodiments, the wagering game establishment can auction such access to certain groups of wagering game players (based on age, gender, monies spent, etc.) to a number of different vendors. Also, vendors having access can change based on the month, the day of the week, time of day, etc. For example, vendor A has access from 12 a.m. to 12 p.m., and vendor B has access from 12 p.m. to 12 a.m.

FIG. 7 depicts a wagering game system having tracking of wagering game player account activity for use by a vendor, according to some example embodiments. FIG. 7 uses the same reference numbers for the components that are the same as those in FIGS. 1-4. In this example, the components that are different from those in FIGS. 1-4 include the communications regarding the vendor messaging. In addition, FIG. 7 also includes a vendor server 798 that includes a process module 799. The process module 799 can be software, firmware, hardware or a combination thereof. Although not shown, the vendor server 798 can also include nonvolatile machine-readable media for storage of data related to vendor messaging.

In operation, the process module 799 of the vendor server 799 transmits a communication 742 that provides a vendor message (see point A). The vendor message can include advertising, discounted or free products or services, etc. The communication 742 is transmitted over the network 114 to the tracking module 138 of the player activity server 106. The tracking module 138 can store the communication 742 in the player account activity database 140. The communication 742 can also include an identification of what group of wagering game players is to receive the vendor message. The communication 742 can also include an identification of which of the player accounts are to receive the vendor messaging. For example, the vendor message can be targeting high value players (e.g., players that spend above a high monetary limit). The communication 742 can also include which of the player accounts are to receive the vendor messaging (i.e., one, some or all of their player accounts receive the vendor messaging). Also, the wagering game player can configure their player accounts not to receive the vendor messaging. For example, the wagering game player can configure their player accounts such that none, one, some or all of their player accounts receive the vendor messaging. In some example embodiments, such vendor messaging can be an opt-in option on the player accounts. Accordingly, the default option is that the wagering game player will not receive the vendor messaging on any of their player accounts. Such data about opting out by the wagering game player can be stored in the player account activity database 140.

Upon receipt by the tracking module 138, the messaging module 136 can output the vendor message (see communication 744 at point B) to the player accounts of the wagering game players that are within the group of wagering game players and that have opted to receive such messaging. In this example, the communication is sent to the account-based wagering account server 116 (for the player account for account-based wagering for the wagering game player 190) and to the online wagering game server 104 (for the player account for online-wagering for the wagering game player 190). However in this example, because of either the vendor election or the player election, the vendor messaging was not transmitted to the player accounts for the resort, the player account for player tracking, and the player account for player's life.

### Example Operations

This section describes operations associated with some example embodiments. In the discussion below, the flowcharts will be described with reference to the block diagrams presented above. However, in some example embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some example embodiments, the operations can be performed in series, while in other embodiments, one or more of the operations can be performed in parallel. Moreover, some example embodiments can perform less than all the operations shown in any flowchart.

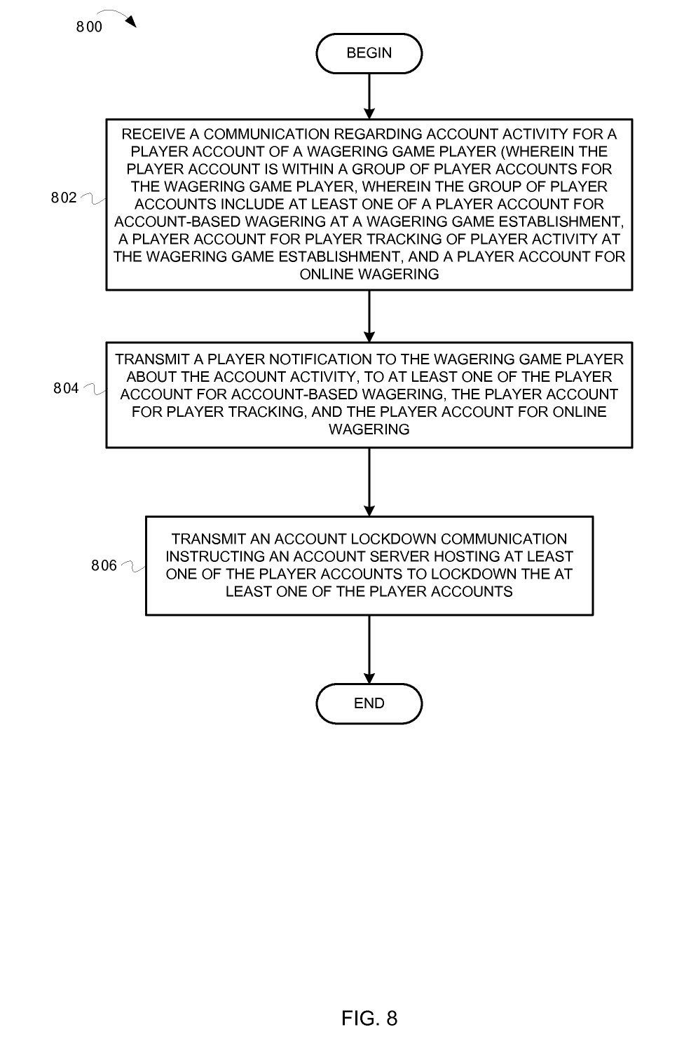

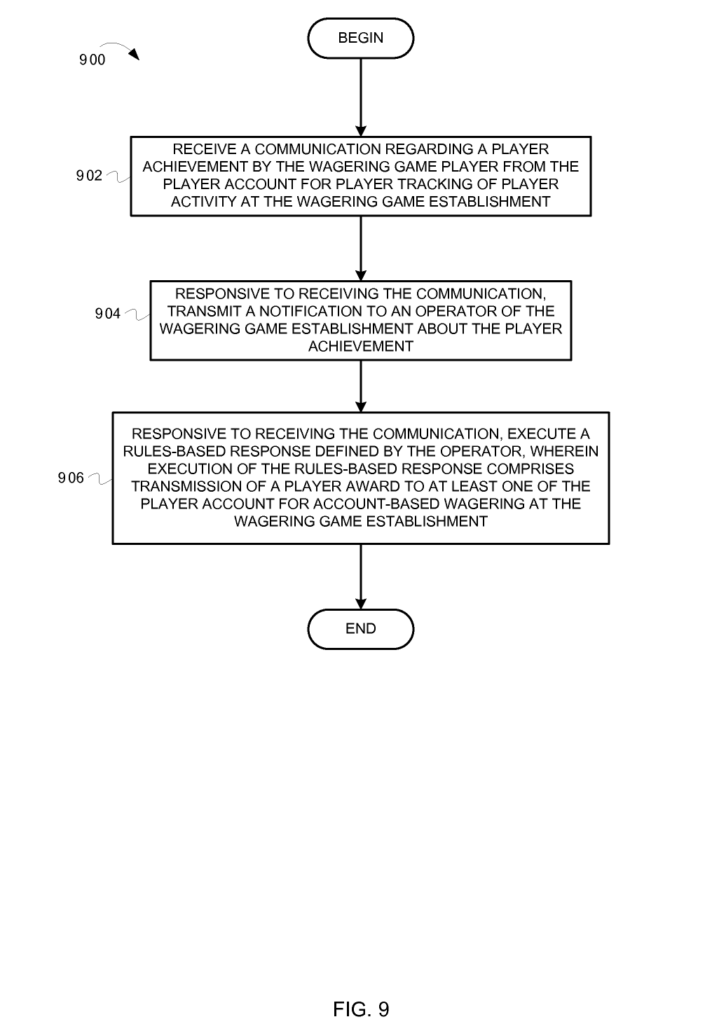

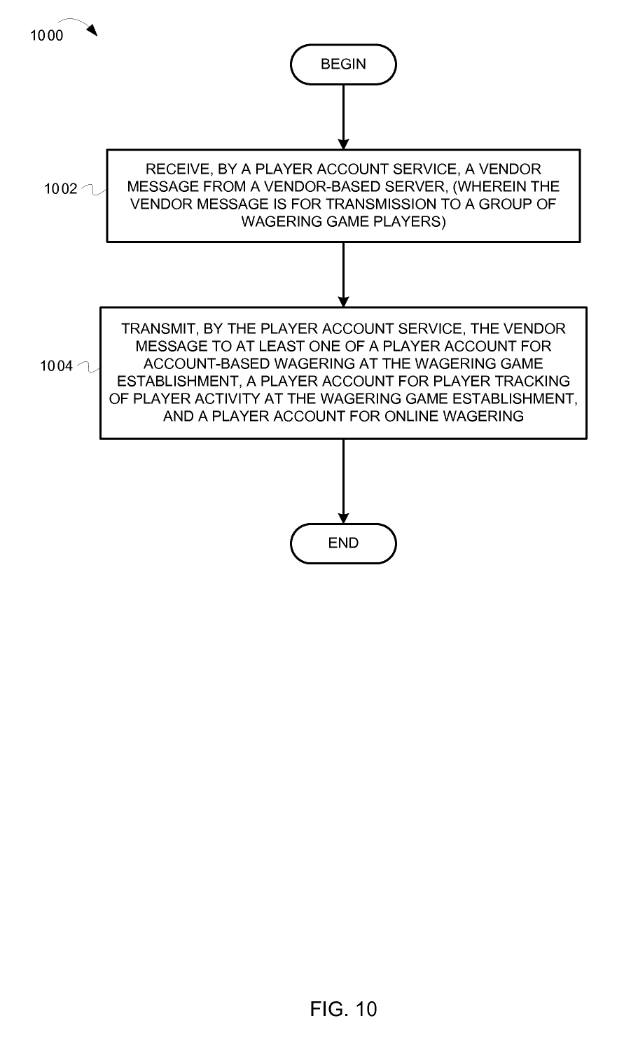

The section will discuss FIGS. 8-10, which provide different example operations for a player account service. While described in separate flowcharts, these example operations can be performed together. The discussion of FIG. 8 will describe example operations by a player account service for player account protection. The discussion of FIG. 9 will describe example operations for use of a player account service by an operator of a wagering game establishment. The discussion of FIG. 10 will describe example operations for use of a player account service by a vendor. FIG. 7 corresponds to the systems of FIGS. 1-4. FIG. 8 corresponds to the systems of FIGS. 5-6. FIG. 9 corresponds to the system of FIG. 7.

FIG. 8 depicts a flowchart for player account protection using a player account service, according to some example embodiments. In this example, operations of a flowchart 800 are performed by the tracking module 138 and the messaging module 136, in reference to FIGS. 1-4. The operations of the flowchart 800 begin at block 802.

At block 802, the tracking module 138 receives a communication regarding account activity for a player account of a wagering game player. The player account can be from a group of player accounts for the wagering game player, wherein the group of player accounts include at least one of a player account for account-based wagering at a wagering game establishment, a player account for player tracking of player activity at the wagering game establishment, and a player account for online wagering. With reference to the example of FIG. 1, the tracking module 138 receives the account activity A 142. The operations of the flowchart 800 continue at block 804.

At block 804, the messaging module 136 transmits a player notification to the wagering game player about the account activity, to at least one of the player account for account-based wagering, the player account for player tracking, and the player account for online wagering. With reference to the example of FIG. 1, the messaging module 136 transmits the communication 148 (shown at point C) for player notification to multiple locations. In this example, the communication 148 is transmitted to the wagering game machine 122, where the wagering game player 190 is playing. In response to receipt of the communication, the wagering game machine 122 can display a message on one of its displays. Also in this example, the communication 148 is being transmitted to the mobile device 110 of the wagering game player 190. For example, the communication 148 can be in the form of an email, a text message, a telephone call, etc. Also in this example, the communication 148 is being transmitted to the computer 108. For example, the communication 148 can be transmitted to one or more of the player accounts (e.g., the online wagering game account, the player's life account, etc.), be transmitted as an email, instant message, etc. The operations of the flowchart 800 continue at block 806.

At block 806, the messaging module 136 transmits an account lockdown communication instructing an account server hosting at least one of the player accounts to lockdown the at least one of the player accounts. With reference to the example of FIG. 1, the messaging module 136 transmits the communication 146 (shown at point C) for account lockdown to the account-based wagering account server 116. In response, the process module 128 locks down player account for account-based wagering such that no further activity can occur in the player account (e.g., logins, cash out, etc.). The operations of the flowchart 800 are complete.

FIG. 9 depicts a flowchart for using a player account service by an operator of a wagering game establishment, according to some example embodiments. In this example, operations of a flowchart 900 are performed by the tracking module 138 and the messaging module 136, in reference to FIGS. 5-6. The operations of the flowchart 900 begin at block 902.

At block 902, the tracking module 136 receives a communication regarding a player achievement by the wagering game player from the player account for player tracking of player activity at the wagering game establishment. With reference to the example of FIG. 6, the tracking module 136 receives the communication 642. In particular, the process module 132 of the player tracking account server 120 transmits a communication 642 regarding a player achievement A (see point A). The communication 642 is transmitted over the network 112 and the network 114 to the tracking module 138 of the player activity server 106. The tracking module 138 can store the communication 642 in the player account activity database 140. The operations of the flowchart 900 continue at block 904.

At block 904, the messaging module 136 transmit a notification to an operator of the wagering game establishment about the player achievement (responsive to receiving the communication). With reference to the example of FIG. 6, the messaging module 136 transmits the communication 646 (shown at point C) for notifying the operator of the achievement and the player being providing award (similar to the communication 544 of FIG. 5). The communication 644 can be provided to an operator 695 through a number of means (e.g., email, text message or telephone call to their mobile device, email or text message to an account that the operator 595 can access, etc.). The operations of the flowchart 900 continue at block 906.

At block 906, the messaging module 136 executes a rules-based response defined by the operator, wherein executing the rules-based response comprises transmitting a player award to at least one of the player account for account-based wagering at the wagering game establishment. With reference to the example of FIG. 6, the messaging module 136 transmits the communication 648 (shown at point D) for a player reward to one or more locations. The communication 648 can be a personal message to the player to one or more of their player accounts (e.g., congratulations message, notification of player entry into a special bonus round at one of the wagering game machines, notification of free credits for wagering game play added to one or more of their accounts, free comps, etc.). Alternatively or in addition, the communication 648 can also be a communication to the wagering game machine where the wagering game player 190 is current logged in and/or the process module 132 in the player tracking server 120. Such a communication can authorize entry of the wagering game player 190 into a bonus round of the wagering game machine where the player is logged in. Alternatively or in addition, the communication 648 can be a communication to the process module 128 of the account based wagering account server 116 to credit the player account with a number of free credits. Alternatively or in addition, the communication 648 can be a communication to the process module 130 of the resort account server 118 to credit the player account for the resort with some type of comp (e.g., free or discounted dinner or merchandise, free or discounted resort hotel room or suite, free or discounted event tickets, etc.). Alternatively or in addition, the communication 648 can be a communication to the process module 134 of the online wagering game server 104 to credit the player account with a number of free credits. The operations of the flowchart 900 are complete.

FIG. 10 depicts a flowchart for using a player account service by a vendor, according to some example embodiments. In this example, operations of a flowchart 1000 are performed by the tracking module 138 and the messaging module 136, in reference to FIG. 7. The operations of the flowchart 1000 begin at block 1002.

At block 1002, the tracking module 138 receives a vendor message from a vendor-based server, (wherein the vendor message is for transmission to a group of wagering game players). With reference to FIG. 7, the tracking module 138 receives the communication 742. In particular, the process module 799 of the vendor server 799 transmits a communication 742 that provides a vendor message (see point A). The vendor message can include advertising, discounted or free products or services, etc. The communication 742 is transmitted over the network 114 to the tracking module 138 of the player activity server 106. The tracking module 138 can store the communication 742 in the player account activity database 140. The communication 742 can also include an identification of what group of wagering game players is to receive the vendor message. The communication 742 can also include an identification of which of the player accounts are to receive the vendor messaging. For example, the vendor message can be targeting high value players (e.g., players that spend above a high monetary limit). The communication 742 can also include which of the player accounts are to receive the vendor messaging (i.e., one, some or all of their player accounts receive the vendor messaging). Also, the wagering game player can configure their player accounts not to receive the vendor messaging. For example, the wagering game player can configure their player accounts such that none, one, some or all of their player accounts receive the vendor messaging. In some example embodiments, such vendor messaging can be an opt-in option on the player accounts. Accordingly, the default option is that the wagering game player will not receive the vendor messaging on any of their player accounts. Such data about opting out by the wagering game player can be stored in the player account activity database 140. The operations of the flowchart 1000 continue at block 1004.

At block 1004, the messaging module 136 transmits the vendor message to at least one of a player account for account-based wagering at the wagering game establishment, a player account for player tracking of player activity at the wagering game establishment, and a player account for online wagering. With reference to FIG. 7, the messaging module 136 outputs the vendor message (see communication 744 at point B) to the player accounts of the wagering game players that are within the group of wagering game players and that have opted to receive such messaging. In this example, the communication is sent to the account-based wagering account server 116 (for the player account for account-based wagering for the wagering game player 190) and to the online wagering game server 104 (for the player account for online-wagering for the wagering game player 190). However in this example, because of either the vendor election or the player election, the vendor messaging was not transmitted to the player accounts for the resort, the player account for player tracking, and the player account for player's life. The operations of the flowchart 1000 are complete.

### Operating Environment

This section describes an example operating environment and presents structural aspects of some embodiments. This section includes discussion about wagering game machine architectures and wagering game networks.

### Wagering Game Machine Architectures

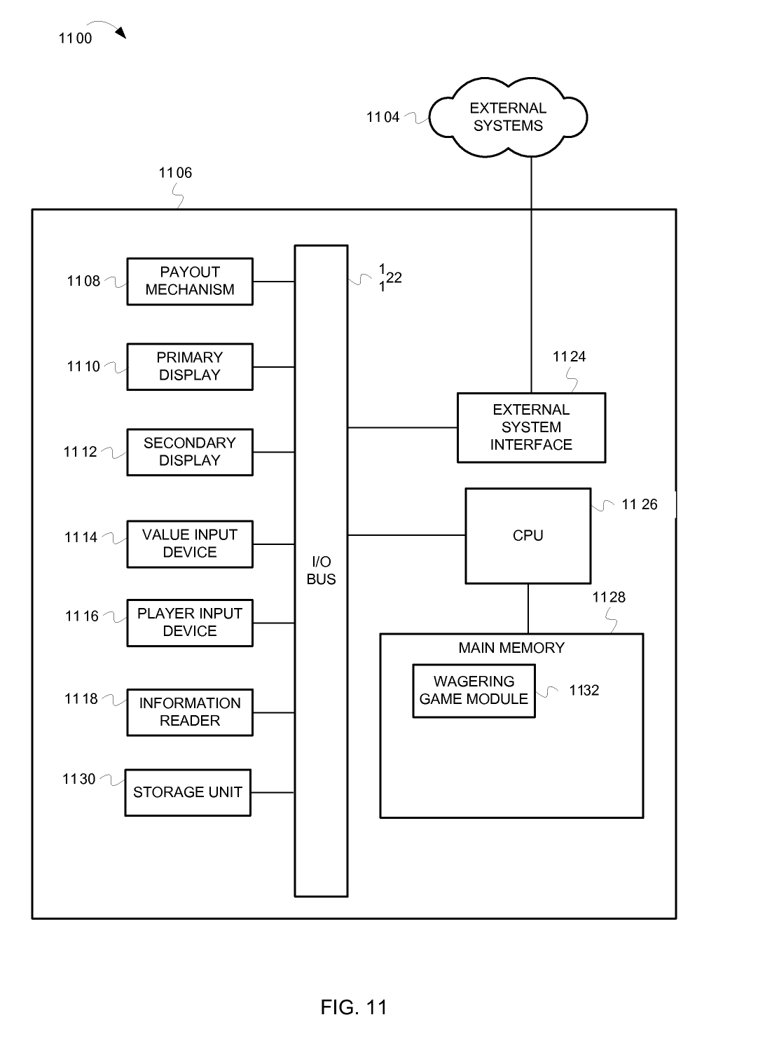

FIG. 11 depicts a block diagram illustrating a wagering game machine architecture, according to some example embodiments. As shown in FIG. 11, the wagering game machine architecture 1100 includes a wagering game machine 1106, which includes a central processing unit (CPU) 1126 connected to main memory 1128. The CPU 1126 can include any suitable processor, such as an Intel® Pentium processor, Intel® Core 2 Duo processor, AMD Opteron™ processor, or UltraSPARC processor. The main memory 1128 includes a wagering game mode 1132. In one embodiment, the wagering game module 1132 can present wagering games, such as video poker, video black jack, video slots, video lottery, etc., in whole or part.

The CPU 1126 is also connected to an input/output (I/O) bus 1122, which can include any suitable bus technologies, such as an AGTL+ frontside bus and a PCI backside bus. The I/O bus 1122 is connected to a payout mechanism 1108, primary display 1110, secondary display 1112, value input device 1114, player input device 1116, information reader 1118, and storage unit 1130. The player input device 1116 can include the value input device 1114 to the extent the player input device 1116 is used to place wagers. The I/O bus 1122 is also connected to an external system interface 1124, which is connected to external systems 1104 (e.g., wagering game networks).

In one embodiment, the wagering game machine 1106 can include additional peripheral devices and/or more than one of each component shown in FIG. 11. For example, in one embodiment, the wagering game machine 1106 can include multiple external system interfaces 1124 and/or multiple CPUs 1126. In one embodiment, any of the components can be integrated or subdivided.

Any component of the architecture 1100 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 11 describes an example wagering game machine architecture, this section continues with a discussion wagering game networks.

### Wagering Game Networks

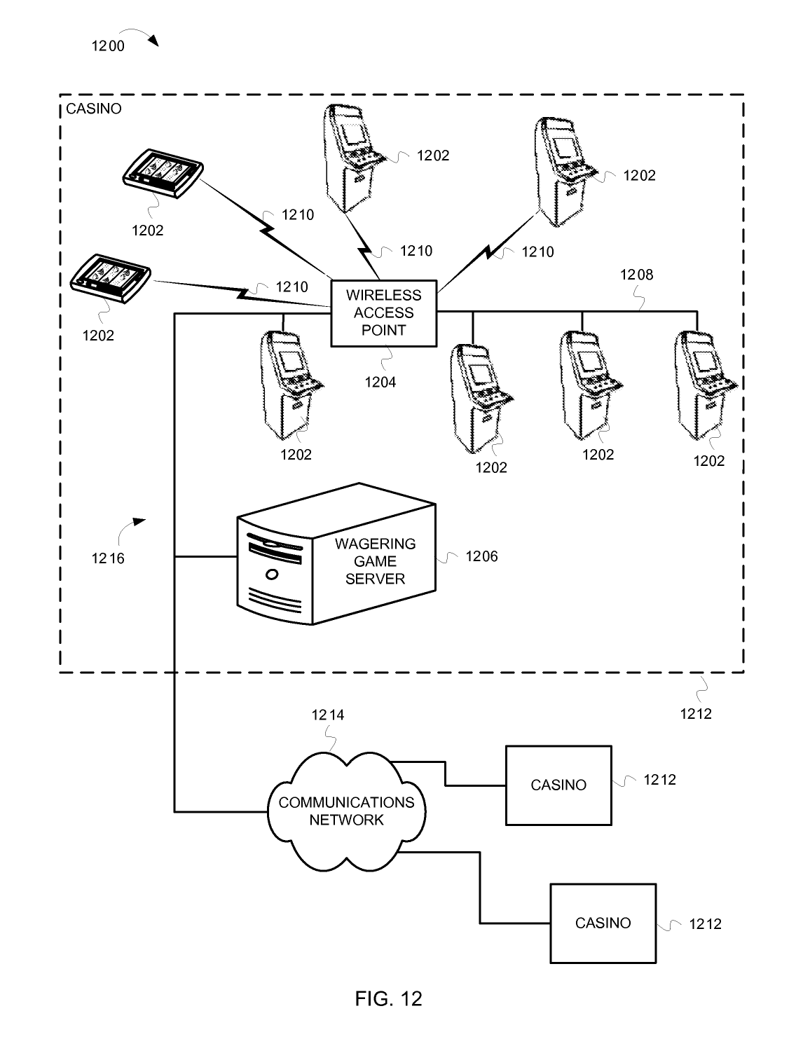

FIG. 12 depicts a block diagram illustrating a wagering game network, according to some example embodiments. As shown in FIG. 12, the wagering game network 1200 includes a plurality of casinos 1212 connected to a communications network 1214.

Each casino 1212 includes a local area network 1216, which includes an access point 1204, a wagering game server 1206, and wagering game machines 1202. The access point 1204 provides wireless communication links 1210 and wired communication links 1208. The wired and wireless communication links can employ any suitable connection technology, such as Bluetooth, 802.11, Ethernet, public switched telephone networks, SONET, etc. In some embodiments, the wagering game server 1206 can serve wagering games and distribute content to devices located in other casinos 1212 or at other locations on the communications network 1214. In some embodiments, the wagering game server 1206 is representative of one or more of the account-based wagering account server 116, the resort account server 118, and the player tracking server 120 illustrated in FIGS. 1-7.

The wagering game machines 1202 described herein can take any suitable form, such as floor standing models, handheld mobile units, bartop models, workstation-type console models, etc. Further, the wagering game machines 1202 can be primarily dedicated for use in conducting wagering games, or can include non-dedicated devices, such as mobile phones, personal digital assistants, personal computers, etc. In one embodiment, the wagering game network 1200 can include other network devices, such as accounting servers, wide area progressive servers, player tracking servers, and/or other devices suitable for use in connection with embodiments of the invention.

In some embodiments, wagering game machines 1202 and wagering game servers 1206 work together such that a wagering game machine 1202 can be operated as a thin, thick, or intermediate client. For example, one or more elements of game play may be controlled by the wagering game machine 1202 (client) or the wagering game server 1206 (server). Game play elements can include executable game code, lookup tables, configuration files, game outcome, audio or visual representations of the game, game assets or the like. In a thin-client example, the wagering game server 1206 can perform functions such as determining game outcome or managing assets, while the wagering game machine 1202 can present a graphical representation of such outcome or asset modification to the user (e.g., player). In a thick-client example, the wagering game machines 1202 can determine game outcomes and communicate the outcomes to the wagering game server 1206 for recording or managing a player's account.

In some embodiments, either the wagering game machines 1202 (client) or the wagering game server 1206 can provide functionality that is not directly related to game play. For example, account transactions and account rules may be managed centrally (e.g., by the wagering game server 1206) or locally (e.g., by the wagering game machine 1202). Other functionality not directly related to game play may include power management, presentation of advertising, software or firmware updates, system quality or security checks, etc.

Any of the wagering game network components (e.g., the wagering game machines 1202) can include hardware and machine-readable media including instructions for performing the operations described herein.

### Example Wagering Game Machine

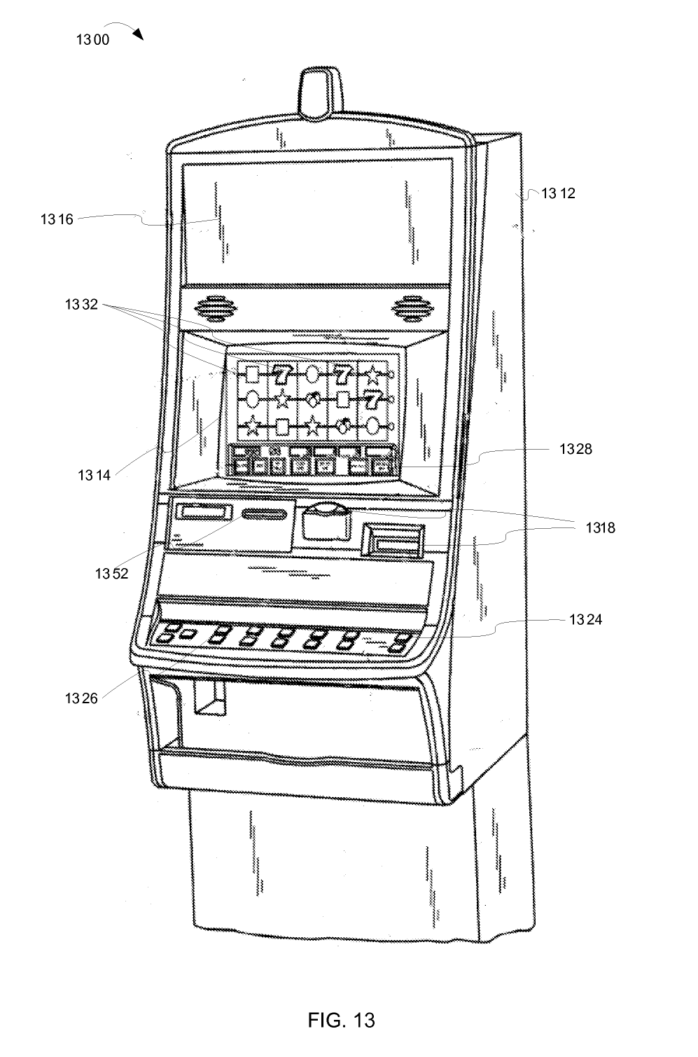

FIG. 13 depicts a perspective view of a wagering game machine, according to some example embodiments. Referring to FIG. 13, a wagering game machine 1300 is used in gaming establishments, such as casinos. According to embodiments, the wagering game machine 1300 can be any type of wagering game machine and can have varying structures and methods of operation. For example, the wagering game machine 1300 can be an electromechanical wagering game machine configured to play mechanical slots, or it can be an electronic wagering game machine configured to play video casino games, such as blackjack, slots, keno, poker, blackjack, roulette, etc.

The wagering game machine 1300 comprises a housing 1312 and includes input devices, including value input devices 1318 and a player input device 1324. For output, the wagering game machine 1300 includes a primary display 1314 for displaying information about a basic wagering game. The primary display 1314 can also display information about a bonus wagering game and a progressive wagering game. The wagering game machine 1300 also includes a secondary display 1316 for displaying wagering game events, wagering game outcomes, and/or signage information. While some components of the wagering game machine 1300 are described herein, numerous other elements can exist and can be used in any number or combination to create varying forms of the wagering game machine 1300.

The value input devices 1318 can take any suitable form and can be located on the front of the housing 1312. The value input devices 1318 can receive currency and/or credits inserted by a player. The value input devices 1318 can include coin acceptors for receiving coin currency and bill acceptors for receiving paper currency. Furthermore, the value input devices 1318 can include ticket readers or barcode scanners for reading information stored on vouchers, cards, or other tangible portable storage devices. The vouchers or cards can authorize access to central accounts, which can transfer money to the wagering game machine 1300.

The player input device 1324 comprises a plurality of push buttons on a button panel 1326 for operating the wagering game machine 1300. In addition, or alternatively, the player input device 1324 can comprise a touch screen 1328 mounted over the primary display 1314 and/or secondary display 1316.

The various components of the wagering game machine 1300 can be connected directly to, or contained within, the housing 1312. Alternatively, some of the wagering game machine's components can be located outside of the housing 1312, while being communicatively coupled with the wagering game machine 1300 using any suitable wired or wireless communication technology.

The operation of the basic wagering game can be displayed to the player on the primary display 1314. The primary display 1314 can also display a bonus game associated with the basic wagering game. The primary display 1314 can include a cathode ray tube (CRT), a high resolution liquid crystal display (LCD), a plasma display, light emitting diodes (LEDs), or any other type of display suitable for use in the wagering game machine 1300. Alternatively, the primary display 1314 can include a number of mechanical reels to display the outcome. In FIG. 13, the wagering game machine 1300 is an “upright” version in which the primary display 1314 is oriented vertically relative to the player. Alternatively, the wagering game machine can be a “slant-top” version in which the primary display 1314 is slanted at about a thirty-degree angle toward the player of the wagering game machine 1300. In yet another embodiment, the wagering game machine 1300 can exhibit any suitable form factor, such as a free standing model, bartop model, mobile handheld model, or workstation console model.

A player begins playing a basic wagering game by making a wager via the value input device 1318. The player can initiate play by using the player input device's buttons or touch screen 1328. The basic game can include arranging a plurality of symbols along a payline 1332, which indicates one or more outcomes of the basic game. Such outcomes can be randomly selected in response to player input. At least one of the outcomes, which can include any variation or combination of symbols, can trigger a bonus game.

In some embodiments, the wagering game machine 1300 can also include an information reader 1352, which can include a card reader, ticket reader, bar code scanner, RFID transceiver, or computer readable storage medium interface. In some embodiments, the information reader 1352 can be used to award complimentary services, restore game assets, track player habits, etc.

### GENERAL

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computerized method comprising:
receiving a communication regarding account activity for a player account of a wagering game player, the player account within a group of player accounts for the wagering game player, wherein the group of player accounts include at least one of a player account for account-based wagering at a wagering game establishment, a player account for player tracking of player activity at the wagering game establishment, and a player account for online wagering; and
executing a rules-based response, in response to receiving the communication regarding the account activity, wherein executing the rules-based response comprises,
transmitting a player notification about the account activity to at least one of the player account for account-based wagering, the player account for player tracking, and the player account for online wagering.

2. The computerized method of claim 1, wherein the executing of the rules-based response comprises transmitting an account lockdown communication instructing an account server to lockdown at least one account of the group of player accounts, wherein the player account where the account activity occurred is different than the at least one of the player accounts to which the account lockdown communication is transmitted.

3. The computerized method of claim 1, wherein the player account where the account activity occurred is different than the player account to which the player notification is transmitted.

4. The computerized method of claim 1, wherein the group of player accounts comprises a player account for online non-wagering game play related to wagering game play at the wagering game establishment.

5. The computerized method of claim 1, further comprising:
receiving a different communication regarding a player achievement by the wagering game player from the player account for player tracking of player activity at the wagering game establishment; and
responsive to receiving the different communication, transmitting a notification to an operator of the wagering game establishment about the player achievement,
responsive to receiving the different communication, executing a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

6. A computerized method comprising:
receiving, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and
transmitting, by the player account service, an account lockdown communication instructing an account server hosting a second player account within the group of player accounts to lockdown the second player account, in response to receiving the communication regarding the account activity for the first player account.

7. The computerized method of claim 6, further comprising:
receiving, at the player account service, a different communication regarding a player achievement by the wagering game player from the player account for player tracking of player activity at the wagering game establishment; and
responsive to receiving the different communication, transmitting, by the player account service, a notification over a network to an operator of the wagering game establishment about the player achievement,
wherein the operator, in response to the player achievement, is to assign a player award to the player over the network to at least one of the player account for account-based wagering at the wagering game establishment, the player account for player tracking of player activity at the wagering game establishment, and the player account for online wagering.

8. The computerized method of claim 7, further comprising:
receiving, by the player account service, a vendor message from a vendor-based server, the vendor message for transmission to a group of wagering game players, wherein the wagering game player is within the group of wagering game players; and
transmitting, by the player account service, the vendor message to at least one of the player account for account-based wagering at the wagering game establishment, the player account for player tracking of player activity at the wagering game establishment, and the player account for online wagering.

9. The computerized method of claim 6, further comprising:
receiving, at the player account service, a different communication regarding a player achievement by the wagering game player from the player account for player tracking of player activity at the wagering game establishment;
responsive to receiving the different communication, transmitting, by the player account service, a notification over a network to an operator of the wagering game establishment about the player achievement; and
responsive to receiving the different communication, executing, by the player account service, a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

10. The computerized method of claim 6, further comprising transmitting, by the player account service, notification to a third player account to notify the wagering game player about the account activity of the first player account.

11. An apparatus comprising:
a processor;
a tracking module, executable on the processor, configured to receiving a communication regarding account activity for a player account of a wagering game player, the player account within a group of player accounts for the wagering game player, wherein the group of player accounts include at least one of a player account for account-based wagering at a wagering game establishment, a player account for player tracking of player activity at the wagering game establishment, and a player account for online wagering; and
a messaging module, executable on the processor, configured to execute a rules-based response defined by the wagering game player, in response to receiving the communication regarding the account activity, wherein, as part of the execution of the rules-based response, the messaging module is configured to,
transmit a player notification to the wagering game player about the account activity, to at least one of the player account for account-based wagering, the player account for player tracking, and the player account for online wagering; and
transmit an account lockdown communication instructing an account server to lockdown at least one account of the group of player accounts.

12. The apparatus of claim 11, wherein the player account where the account activity occurred is different than the at least one of the player accounts to which the account lockdown communication is transmitted.

13. The apparatus of claim 11, wherein the player account where the account activity occurred is different than the player account to which the player notification is transmitted.

14. The apparatus of claim 11, wherein the group of player accounts comprise a player account for online non-wagering game play related to wagering game play at the wagering game establishment.

15. The apparatus of claim 11,
wherein the tracking module is configured to receive a different communication regarding a player achievement by the wagering game player from the player account for player tracking of player activity at the wagering game establishment;
wherein the messaging module is configured to transmit, responsive to receiving the different communication, a notification to an operator of the wagering game establishment about the player achievement;
wherein the messaging module is configured to execute, responsive to receiving the different communication, a rules-based response defined by the operator; and
wherein as part of the execution of the rules-based response, the messaging module is configured to transmit a player award to at least one of the player account for account-based wagering at the wagering game establishment, the player account for player tracking of player activity at the wagering game establishment, and the player account for online wagering.

16. One or more machine-readable storage media including instructions which, when executed by one or more processors, cause the one or more processors to perform operations comprising:
receive, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and
transmit, by the player account service, an account lockdown communication instructing an account server hosting a second player account within the group of player accounts to lockdown the second player account, in response to receiving the communication regarding the account activity for the first player account.

17. The one or more machine-readable storage media of claim 16, wherein the operations comprise:
receiving, at the player account service, a different communication regarding a player achievement by the wagering game player from the player account for player tracking of player activity at the wagering game establishment; and
responsive to receiving the different communication, transmitting, by the player account service, a notification over a network to an operator of the wagering game establishment about the player achievement,
wherein the operator, in response to the player achievement, is to assign a player award to the player over the network to at least one of the player account for account-based wagering at the wagering game establishment, the player account for player tracking of player activity at the wagering game establishment, and the player account for online wagering.

18. The one or more machine-readable storage media of claim 17, wherein the operations comprise:
receive, by the player account service, a vendor message from a vendor-based server, the vendor message for transmission to a group of wagering game players, wherein the wagering game player is within the group of wagering game players; and
transmitting, by the player account service, the vendor message to at least one of the player account for account-based wagering at the wagering game establishment, the player account for player tracking of player activity at the wagering game establishment, and the player account for online wagering.

19. The one or more machine-readable storage media of claim 16, wherein the operations comprise:
receive, at the player account service, a different communication regarding a player achievement by the wagering game player from the player account for player tracking of player activity at the wagering game establishment;
responsive to receipt of the different communication, transmission, by the player account service, a notification over a network to an operator of the wagering game establishment about the player achievement; and
responsive to receiving the different communication, executing a rules-based response defined by the operator, wherein executing the rules-based response comprises transmitting a player award to at least one of the player account for account-based wagering at the wagering game establishment, the player account for player tracking of player activity at the wagering game establishment, and the player account for online wagering.

20. The one or more machine-readable storage media of claim 16, wherein the operations comprise:
transmit, by the player account service, notification to a third player account to notify the wagering game player about the account activity of the first player account.

21. An apparatus comprising:
means for receiving, at a player account service, a communication regarding account activity for a first player account of a wagering game player, the first player account within a group of player accounts for the wagering game player, wherein the group of player accounts include at least one of a player account for account-based wagering at a wagering game establishment, a player account for player tracking of player activity at the wagering game establishment, and a player account for online wagering; and
means for transmitting, by the player account service, an account lockdown communication instructing an account server hosting a second player account within the group of player accounts to lockdown the second player account, in response to receiving the communication regarding the account activity for the first player account.

22. The apparatus of claim 21, further comprising:
means for receiving, at the player account service, a different communication regarding a player achievement by the wagering game player from the player account for player tracking of player activity at the wagering game establishment; and
means for transmitting, responsive to receiving the different communication and by the player account service, a notification over a network to an operator of the wagering game establishment about the player achievement,
wherein the operator, in response to the player achievement, is to assign a player award to the player over the network to at least one of the player account for account-based wagering at the wagering game establishment, the player account for player tracking of player activity at the wagering game establishment, and the player account for online wagering.

23. The apparatus of claim 22, further comprising:
means for receiving, by the player account service, a vendor message from a vendor-based server, the vendor message for transmission to a group of wagering game players, wherein the wagering game player is within the group of wagering game players; and
means for transmitting, by the player account service, the vendor message to at least one of the player account for account-based wagering at the wagering game establishment, the player account for player tracking of player activity at the wagering game establishment, and the player account for online wagering.

24. The apparatus of claim 21, further comprising:
means for receiving, at the player account service, a different communication regarding a player achievement by the wagering game player from the player account for player tracking of player activity at the wagering game establishment;
means for transmitting, responsive to receiving the different communication and by the player account service, a notification over a network to an operator of the wagering game establishment about the player achievement; and
means for executing, responsive to receiving the different communication and by the player account service, a rules-based response defined by the operator, wherein means for executing the rules-based response comprises means for transmitting a player award to at least one of the player account for account-based wagering at the wagering game establishment, the player account for player tracking of player activity at the wagering game establishment, and the player account for online wagering.

25. The apparatus of claim 21, further comprising means for transmitting, by the player account service, notification to a third player account to notify the wagering game player about the account activity of the first player account.
